(19) United States
(12) Patent Application Publication
(10) Pub. No.: US 2026/0271984 A1
(43) Pub. Date: Sep. 17, 2026

(54) METHOD AND MACHINE FOR MAKING A PLANT-BASED WEB

(71) Applicant: COMAS - COSTRUZIONI MACCHINE SPECIALI - S.P.A., Silea (Trevis) (IT)

(72) Inventors: Giulia BIGAZZI, Silea (Treviso) (IT); Giulio GOBBO, Silea (Treviso) (IT); Alessandro GRANZOTTO, Silea (Treviso) (IT)

(21) Appl. No.: 19/167,588

(22) PCT Filed: Mar. 11, 2024
(86) PCT No.: PCT/IB2024/052320

§ 371 Date: Sep. 22, 2025

(30) Foreign Application Priority Data
Mar. 22, 2023 (IT) 102023000005457

(51) Int. Cl. A24B 3/14

(52) U.S. Cl. CPC A24B 3/14

(57) ABSTRACT

A machine for making a plant-based web comprises a kneader including a containing frame provided with at least one feeding inlet and at least one discharge outlet. The kneader comprises-includes a motor-driven kneading shaft mounted inside the containing frame The machine includes a first feed line, operatively connected to the at least one feeding inlet and configured to feed a dry, ground and/or powdered product and a second feed line, separate from the first feed line, operatively connected to the at least one feeding inlet (103, 104) and configured to feed one or more liquids to make a mixture. The machine also includes a vertical laminating device, mounted under the discharge outlet for forming a web having a calibrated thickness.

### TECHNICAL FIELD

This invention addresses the tobacco industry and relates to a machine and a method for making a plant-based web.

### BACKGROUND ART

Known in the prior art are what are known as “batch machines” for making plant-based webs. These machines essentially comprise a closed-space kneader configured for making a mixture by mixing at least one dry, ground and/or powdered product with one or more mixing liquids, and a laminating device, located downstream of the kneader and configured for converting the mixture into a homogeneous web.

Structurally, the kneader, which is of the tilting type, comprises a containing frame which internally defines a mixing space having a generic, open-top structure. The kneader also comprises a motor-driven mixing shaft, typically of the vane type, located in the mixing space and rotatably mounted to the containing frame.

The ingredients are fed simultaneously into the mixing space and beaten together by the kneading shaft.

The kneader also comprises a tilting system to convert the containing frame from a loading configuration, suitable for feeding and mixing the ingredients, to a tilted configuration, suitable for discharging the mixture from the open top.

The machine also comprises other processing units, located downstream of the kneader: for example, a portioning device, located under the kneader, to divide the mixture into a plurality of pats, followed by a unit for re-kneading the pats. Next, the material obtained from the re-kneaded pats is conveyed to a laminating device. The laminating device is typically a horizontal laminating device.

The Applicant has noticed that although this technology is satisfactorily practicable, it can be further improved, in particular in terms of simplifying the machine, in terms of operating versatility and in terms of optimizing the process with regard to process times and costs.

First of all, feeding all the ingredients simultaneously may result in a mixture that is not perfectly homogeneous. In effect, if the powders and the liquid remain in contact for too long, the tobacco tends to absorb part of the liquid needed to start the kneading process. Furthermore, if there is more than one dry, ground and/or powdered ingredient, some portions of the mixture may have different concentrations of the ingredients, thus worsening the problem of non-uniformity in the mixture. At present, these problems are overcome by prolonging the mixing times but, in so doing, production costs (as well as process times) are increased.

Secondly, the vane type shaft does not allow optimum mixing of the ingredients and does not allow their total recruitment: in effect, part of the mixture may separate from the mass being kneaded and adhere to the inside wall of the kneader. As a result, not only is there less mixture available for productive use but the cleaning and maintenance costs of the kneader are higher.

Furthermore, the overall architecture of the machine is not optimized in terms of floor space occupied. The sequence of numerous processing units creates a cumbersome machine which, in many cases, becomes difficult to manage.

### DISCLOSURE OF THE INVENTION

In this context, the technical purpose of this invention is, therefore, to provide a machine and a method for making a plant-based web which are free of the disadvantages of the prior art.

This invention therefore has for an aim to provide a machine and a method for making a plant-based web and offering a solution which is and structurally simplified and less encumbered than the prior art solutions.

A further aim of the invention is to provide a machine and a method for making a plant-based web which allow lowering production and maintenance costs and energy consumption.

A further aim of the invention is to provide a machine and a method for making a plant-based web which have high operational flexibility and which, in particular, can be used to obtain webs in different sizes and to different specifications.

A further aim of the invention is to provide a machine and a method for making a plant-based web which allow obtaining a homogeneous mixture.

The aims are substantially achieved by a machine and a method in accordance with the features set out in the accompanying claims 1 and 10, respectively, and/or in one or more of the claims dependent thereon.

### BRIEF DESCRIPTION OF DRAWINGS

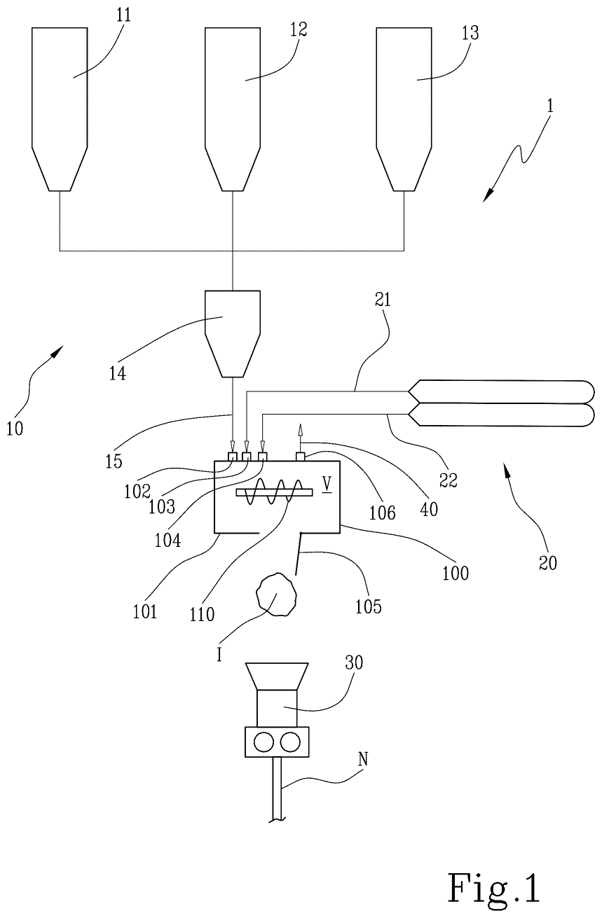

Further features of the invention and its advantages are more apparent in the following exemplary, hence non-limiting description of a preferred but non-exclusive embodiment of a machine and method for making a plant-based web, as illustrated in FIG. 1, which shows, by way of an exemplary, hence non-limiting, preferred embodiment of a machine for making a plant-based web according to the invention.

### DETAILED DESCRIPTION OF PREFERRED EMBODIMENTS OF THE INVENTION

The reference numeral 1 in the accompanying drawing denotes in its entirety a machine for making a plant-based web N.

The expression “plant-based” is used to mean a reconstituted material, preferably a material obtained by mixing one or more plant components such as, for example, tobacco, hemp, aromatic leaves, cellulose and at least one liquid component such as water, for example. Preferably, but not necessarily, the machine 1 is intended for forming a plant-based web N of the tobacco industry. It is, however, specified that the same machine 1 can be used to make webs of generic reconstituted material (in particular of plant origin), not necessarily tobacco, in line with the generic nature of the invention (for example, hemp, aromatic leaves, cellulose or others still).

As shown in the drawing, the machine 1 comprises a first feed line 10, configured to feed a dry, ground and/or powdered product, and a second feed line 20, configured to feed one or more liquids.

The machine 1 also comprises a kneader 100 adapted to receive the at least one dry, ground and/or powdered product from the first feed line 10 and the at least one liquid from the second feed line 20, and configured to make a mixture I with the at least one dry, ground and/or powdered product and the at least one liquid.

Structurally, the kneader 100 comprises a containing frame 101 which internally defines a cylindrical mixing space V. Preferably, the kneader 100 has a horizontal axis.

The kneader 100 comprises a motor-driven kneading shaft 110 mounted inside the containing frame 101. Preferably, the kneading shaft 110 is rotatable about a horizontal axis. Preferably, the axis of rotation of the kneading shaft 110 coincides with the horizontal axis of the containing frame 101.

The containing frame 101 of the kneader 100 is fixed.

Preferably, the containing frame 101 is elongated in shape along its axis of extension.

According to an aspect of this invention, the kneading shaft 110 is of the screw type, of the vane type or of the ploughshare type. In particular, the kneading shaft 110 is configured to apply a scraping action on the wall of the mixing space V.

Preferably, the reciprocal dimensions of the containing frame 101 and kneading shaft 110 are such as to define a gap of 1 mm to 5 mm, preferably 2 mm to 3 mm, between the inside walls of the containing frame 101 and the vanes or other radial protrusions of the kneading shaft 110.

Advantageously, these technical features allow the kneading shaft 110 to blend and knead the ingredients in optimal manner and also allow the kneading shaft 110 to totally recruit the ingredients by scraping them off the inside wall of the mixing space V, thereby considerably limiting waste.

The kneader 100 is also provided with at least one feeding inlet 102, 103, 104 made in an upper portion of the containing frame 101, and at least one discharge outlet 105 made in a lower portion of the containing frame 101.

The at least one feeding inlet 102, 103, 104 is operatively connected to the first feed line 10 and to the second feed line 20.

In an embodiment, as shown in FIG. 1, the first feed line 10 is connected to the at least one respective feeding inlet 102, while the second feed line 20 is connected to at least one respective feeding inlet 103, 104. The second feed line 20 and the first feed line 10 are thus separate and are connected to different feeding inlets.

In an embodiment of this invention, the first feed line 10 comprises at least a first feed branch 11 for feeding a first type of dry, ground and/or powdered material, and at least a second feed branch 12, distinct from the first branch 11, for feeding a second type of dry, ground and/or powdered material.

The first feed line 10 preferably comprises at least a third feed branch 13, distinct from the first branch and from the second branch, for feeding a third type of dry, ground and/or powdered material.

Generally speaking, the number of feed branches 11, 12, 13 of the first feed line 10 is a design choice which depends on the intended use of the machine 1.

Advantageously, these technical features make the machine 1 extremely versatile.

In the embodiment shown in FIG. 1, the machine 1 comprises a metering tank 14, located on the first feed line 10 upstream of the kneader 100: the metering tank 14 is connected to at least some of the feed branches 11, 12, 13, preferably to all of them, and has a connecting duct 15 connected to the at least one feeding inlet 102, preferably a single connecting duct 15 connected to a respective feeding inlet 102.

The metering tank 14 may be provided with a stirrer for mixing the materials in the dry state or no such stirrer may be provided. In the latter case, the different materials in the dry state may be fed simultaneously so that they are mixed together as they enter the metering tank, or they may be fed in succession so that they form a layered charge which is then sent to the kneader 100.

In a variant embodiment not illustrated, the machine 1 does not comprise the metering tank 14 but each of the aforesaid feed branches 11, 12, 13 is connected to a respective feeding inlet so that the materials are fed directly to the kneader 100.

The second feed line 20 in turn comprises at least a first feed branch 21 for feeding a first type of liquid, and preferably at least a second feed branch 22, distinct from the first feed branch 21, for feeding a second type of liquid.

As in the case of the first feed line 10, the number of feed branches 21, 22 of the second feed line 20 is a design choice which depends on the intended use of the machine 1.

Preferably, each branch 21, 22 of the second feed line 20 is connected to a respective feeding inlet 103, 104. In other words, the kneader 100 comprises a respective feeding inlet 103, 104 for each of the branches 21, 22 of the second feed line 20.

Preferably, the kneader 100 is a “batch kneader”, that is to say, configured to mix and form the mixture (discontinuously) in successive cycles, repeated one after the other each time the mixture is discharged from the kneader 100.

The machine 1 also comprises a vertical laminating device 30, located downstream of the kneader 100 and configured for processing the mixture I to form a web N having a calibrated thickness.

In an embodiment, illustrated in FIG. 1, the discharge outlet 105 of the kneader 100 is located above the vertical laminating device 30. In other words, the vertical laminating device 30 is located under the discharge outlet 105 and is configured (for example, via a convergent inlet) to receive the mixture I discharged from the kneader 100, in particular by gravity, and to form a web N having a calibrated thickness. Preferably, the vertical laminating device 30 is located directly downstream of the discharge outlet 105. In other words, there are no other units or devices located between the discharge outlet 105 and the vertical laminating device 30.

Advantageously, these technical features make the machine structurally simple and manageable.

According to an aspect of this invention, the discharge outlet 105 comprises a reclosable hatch configured to selectively adopt a closed configuration, where it closes the discharge outlet 105 so the materials can be loaded and mixed, and an open configuration, where it opens the discharge outlet 105 so the mixed materials, that is, the mixture I can be discharged. The reclosable hatch is preferably of a hinged type.

In the closed configuration of the discharge outlet 105, the hatch preferably has an inside surface which is coplanar with the inside surface of the mixing space V. In other words, in the closed configuration, the inside surface of the hatch and the inside surface of the mixing space V define a surface which is substantially “uninterrupted”, that is, without noticeable irregularities and/or indentations.

Advantageously, this technical feature reduces, or even eliminates, the buildup of scraps of mixture I and prevents damage to the kneading shaft 110.

Furthermore, in an embodiment, the discharge outlet 105 has a predominant direction of extension parallel to the kneading shaft 110. This solution is particularly advantageous in the case where the kneader 100 is also elongated in shape along the horizontal axis of extension of the containing frame 101, making it easier for the mixture to be completely discharged.

According to an aspect of this invention, the machine 1 also comprises a venting circuit of the kneader 100, connected to a venting outlet 106 made in an upper portion of the containing frame 101.

In a variant not illustrated, there is also a conveyor interposed between the kneader 100 and the vertical laminating device 30 and configured to receive the discharged mixture I directly from the kneader 100, in particular by gravity, and to convey the mixture to the vertical laminating device 30, in particular by discharging the mixture I into the vertical laminating device 30 by gravity.

The term “directly” in both embodiments is used to mean that there are no other, intermediate devices for processing the mixture (for example, for processes such as humidification, drying, application of additives, compression, cutting, and so on). In this situation, the conveyor does not therefore fall within the definition of “processing device” but simply constitutes a means of transfer.

Operatively, the step of discharging the mixture I from the kneader 100 is carried out by releasing the mixture I from the discharge outlet of the kneader 100 by gravity onto a first stretch of the conveyor and the subsequent step of feeding the mixture I to the vertical laminating device 30 is carried out by a subsequent step of releasing the mixture I, in particular by gravity, from a second stretch of the conveyor into the vertical laminating device 30.

Also, in this non-illustrated embodiment, the vertical laminating device 30 is preferably disposed at a greater elevation than the kneader 100 and the mixture is raised by the conveyor.

Preferably, the first stretch of the conveyor is disposed at a greater elevation than the second stretch, and the step of feeding the mixture I to the vertical laminating device 30 comprises a step of raising the mixture I by means of the conveyor.

Preferably, the conveyor is a linear conveyor, and more preferably, a belt or mesh conveyor.

Also an object of this invention is a method for making a plant-based web N. Preferably, the method is carried out using the machine 1 described above. Therefore, the method for making a plant-based web will now be described in an embodiment of it with reference to the machine 1 used to implement the method.

The method comprises a step of feeding a first quantity of at least one dry, ground and/or powdered product into the mixing space V of the kneader 100 through a first feed line 10, followed by a step of feeding a second quantity of at least one liquid into the mixing space V of the kneader 100 through the second feed line 20.

The step of feeding the first quantity of at least one dry, ground and/or powdered product may be carried out by feeding predetermined quantities of different types of dry, ground and/or powdered material which together define the aforesaid first quantity. The type and number of materials, as well as their respective quantities, are selected as a function of the web N, hence of the mixture I, to be made.

In a preferred embodiment, the method comprises feeding a predetermined quantity of a first type of dry, ground and/or powdered product into the kneader 100 through the respective first feed branch 11 and feeding a predetermined quantity of a second type of dry, ground and/or powdered product into the kneader 100 through the respective second feed branch 12. Preferably, the method also comprises feeding a predetermined quantity of a third type of dry, ground and/or powdered material into the kneader 100 through a respective third feed branch 13.

For example, the first type of dry, ground and/or powdered product might be tobacco, the second type of dry, ground and/or powdered product might be cellulose, while the third type of dry, ground and/or powdered product might be a binder, such as carboxymethyl cellulose.

According to an aspect of this invention, feeding the two or more types of dry, ground and/or powdered materials is carried out by intermittently and/or alternately feeding the two or more types of dry, ground and/or powdered materials so as to obtain a dry, layered product, preferably comprising at least two layers of each type of dry material.

Advantageously, this improves the mixing and intermingling of the different types of dry, ground and/or powdered material before the step of kneading proper starts. Advantageously, also, layering the ingredients fed in this way allows reducing mixing times and obtaining a perfectly homogeneous mixture I with less expenditure of energy, thus reducing production costs.

In a preferred embodiment of the method, the step of feeding a predetermined quantity of a first type of dry, ground and/or powdered material and a predetermined quantity of a second type of dry, ground and/or powdered material into the kneader 100 is carried out by feeding the quantities of dry, ground and/or powdered material into the metering tank 14 to obtain a dry, pre-metered charge and then transferring the dry, pre-metered charge into the kneader 100.

According to an aspect of this invention, the method comprises a step of preliminarily mixing the two or more types of dry, ground and/or powdered materials, carried out before the step of feeding the at least one liquid into the kneader 100. Preferably, the preliminary mixing is carried out in the kneader 100. According to an operational aspect, the step of preliminary mixing is carried out by operating the kneading shaft 110 at a speed greater than 50 rpm, preferably greater than 70 rpm.

In other words, the dry, ground and/or powdered material is fed into the kneader 100 and undergoes preliminary mixing via the kneading shaft 110. When the step of preliminary mixing is over, the second quantity of the at least one liquid is fed into the kneader 100.

Advantageously, the step of preliminary mixing allows obtaining a homogeneous dry, ground and/or powdered product so as to facilitate the subsequent step of mixing the dry product with the mixing liquids.

Advantageously, therefore, the preliminary mixing of the dry ingredients allows reducing the time needed for the subsequent step of kneading the mixture I and obtaining a perfectly homogeneous mixture I with less expenditure of energy, thus reducing production costs.

As to the feeding of the second quantity of at least one liquid, the method comprises feeding a predetermined quantity of liquid into the kneader 100 through the respective first feed branch 21 of the second feed line 20 and feeding a predetermined quantity of at least a second type of liquid into the kneader 100 through the respective second feed branch 22 of the second feed line 20.

For example, the first type of liquid may be water while the second type of liquid may be glycerine.

When both the steps of feeding have been carried out, the method comprises a step of mixing the first quantity of dry product with the second quantity of liquid to obtain the aforesaid mixture I.

The step of mixing is carried out inside the kneader 100 by the aforesaid kneading shaft 110 which is of a screw type, of a vane type or of a ploughshare type, and which, in particular, applies a scraping action on the inside wall of the mixing space V.

Preferably, the step of kneading is carried out by operating the kneading shaft 110 at a speed greater than 150 rpm, preferably greater than 180 rpm.

Still more preferably, the step of kneading is carried out by operating the kneading shaft 110 at a speed between 185 rpm and 200 rpm.

When kneading is over and the mixture I made, the method comprises the step of discharging the mixture I into the vertical laminating device 30 located under the kneader 100 to make the web N. Preferably, in the step of discharging, the mixture I is conveyed from the discharge outlet 105 of the kneader 100 directly into the vertical laminating device 30.

In the embodiment illustrated, this step is accomplished by direct discharge by gravity.

In the embodiment that is not illustrated, this step is accomplished by conveying the mixture from the kneader to the vertical laminating device via the conveyor without carrying out any intermediate process on the mixture.

The invention achieves the preset aims overcoming the drawbacks of the prior art.

In particular, the machine 1 of this invention allows the process for forming the mixture I and the plant-based web N to be made more efficient and less energy wasteful, while at the same time ensuring that the mixture I and the web N are of top quality. Moreover, the machine 1 of this invention allows the mixture to be formed at a higher speed.

1. A machine for making a plant-based web, comprising:
a kneader comprising a containing frame internally defining a mixing space having a cylindrical shape and provided with at least one feeding inlet made in an upper portion of the containing frame and at least one discharge outlet made in a lower portion of the containing frame the kneader comprising a motor-driven kneading shaft mounted inside the containing frame;
a first feed line, operatively connected to the at least one feeding inlet and configured to feed a dry, ground and/or powdered product;
a second feed line, operatively connected to the at least one feeding inlet and configured to feed one or more mixing liquids, the second feed line being separate from the first feed line; and
a vertical laminating device disposed and configured to receive the mixture discharged by the kneader and to process the mixture to form a web having a calibrated thickness.

2. The machine according to claim 1, wherein the vertical laminating device is disposed under the kneader to receive the discharged mixture directly from the kneader, in particular by gravity.

3. The machine according to claim 1, further comprising a conveyor interposed between the kneader and the vertical laminating device and configured to receive the discharged mixture directly from the kneader, in particular by gravity, and to convey the mixture to the vertical laminating device, in particular by discharging the mixture into the vertical laminating device by gravity.

4. The machine according to claim 3, wherein the vertical laminating device is disposed at a greater elevation than the kneader and wherein said conveyor raises the mixture.

5. The machine according to claim 1, wherein there are no processing units between the kneader and the vertical laminating device.

6. The machine according to claim 1, wherein the kneader has a horizontal axis and wherein the kneading shaft is rotatable about a horizontal axis.

7. The machine according to claim 1, wherein the first feed line comprises at least a first feed branch for feeding a first type of dry, ground and/or powdered material, and at least a second feed branch, distinct from the first branch, for feeding a second type of dry, ground and/or powdered material; the feed line preferably comprising at least a third feed branch, distinct from the first branch and from the second branch, for feeding a third type of dry, ground and/or powdered material.

8. The machine according to claim 7, comprising a metering tank, located on the first feed line upstream of the kneader; the metering tank being connected to the feed branches and having a connecting duct connected to the at least one feeding inlet preferably a single connecting duct connected to a respective feeding inlet.

9. The machine according to claim 7, wherein each feed branch is connected to a respective, separate feeding inlet.

10. The machine according claim 1, wherein the second feed line comprises at least a first feed branch for feeding a first type of liquid, and preferably at least a second feed branch, distinct from the first feed branch, for feeding a second type of liquid;
preferably, each branch of the second feed line being connected to a respective feeding inlet.

11. The machine according to claim 1, wherein the discharge outlet comprises a reclosable hatch configured to selectively adopt a closed configuration, where it closes the discharge outlet so the materials can be loaded and kneaded, and an open configuration, where it opens the discharge outlet so the kneaded materials can be discharged; in the closed configuration of the discharge outlet, the hatch preferably having an inside surface which is coplanar with the inside surface of the mixing space.

12. The machine according to claim 1, wherein the kneading shaft is of a screw type, of a vane type or of a ploughshare type, and is configured to apply a scraping action on the wall of the mixing space.

13. The machine according to claim 1, comprising a venting circuit of the kneader, connected to a venting outlet made in an upper portion of the containing frame.

14. A method for making a plant-based web, in particular implemented by a machine according to claim 1, comprising the following steps:
feeding a first quantity of at least one dry, ground and/or powdered product into a mixing space of a kneader through a first feed line;
feeding a second quantity of at least one liquid into the mixing space of the kneader through a second feed line;
mixing the first quantity of dry product with the second quantity of liquid to obtain a mixture;
discharging the mixture from the kneader and feeding the mixture to a vertical laminating device;
laminating the mixture via the vertical laminating device to obtain a continuous web having a calibrated thickness.

15. The method according to claim 14, wherein the vertical laminating device is disposed under the kneader and wherein said step of feeding the mixture to the vertical laminating device is carried out by gravity.

16. The method according to claim 14, wherein said step of feeding the mixture to the vertical laminating device is carried out by a conveyor, preferably a linear conveyor, and more preferably, a belt or mesh conveyor.

17. The method according to claim 16, wherein said step of discharging the mixture from the kneader is carried out by releasing the mixture from the discharge outlet of the kneader by gravity onto a first stretch of the conveyor, and wherein said step of feeding the mixture to the vertical laminating device is carried out by a subsequent step of releasing the mixture, in particular by gravity, from a second stretch of the conveyor into the vertical laminating device.

18. The method according to claim 16, wherein said first stretch of the conveyor is disposed at a greater elevation than the second stretch, and wherein said step of feeding the mixture to the vertical laminating device comprises a step of raising the mixture by means of the conveyor.

19. The method according to claim 14, wherein the step of feeding a first quantity of at least one dry, ground and/or powdered product comprises the following sub-steps:
feeding a predetermined quantity of a first type of dry, ground and/or powdered material into the kneader through a respective first feed branch;
feeding a predetermined quantity of at least a second type of dry, ground and/or powdered material into the kneader through a respective second feed branch;
the step of feeding a first quantity of at least one dry, ground and/or powdered product preferably comprising a sub-step of feeding a predetermined quantity of a third type of dry, ground and/or powdered material into the kneader through a respective third feed branch.

20. The method according to claim 19, comprising a step of preliminarily mixing the two or more types of dry, ground and/or powdered materials, carried out before the step of feeding the at least one liquid into the kneader.

21. The method according to claim 20, wherein preliminarily mixing is carried out in the kneader.

22. The method according to claim 19, wherein feeding the two or more types of dry, ground and/or powdered materials is carried out by intermittently and/or alternately feeding the two or more types of dry, ground and/or powdered materials so as to obtain a dry, layered product, preferably comprising at least two layers of each type of dry material.

23. The method according to claim 19, wherein the step of feeding a predetermined quantity of a first type of dry, ground and/or powdered material and a predetermined quantity of a second type of dry, ground and/or powdered material into the kneader is carried out by feeding the quantities of dry, ground and/or powdered material into a metering tank to obtain a dry, pre-metered charge and then transferring the dry, pre-metered charge into the kneader.

24. The method according to claim 14, wherein the step of kneading is carried out by a kneading shaft which is of a screw type, of a vane type or of a ploughshare type, and which, in particular, applies a scraping action on an inside wall of the mixing space.

25. The method according to claim 24, wherein the step of mixing is carried out by operating the kneading shaft at a speed greater than 50 rpm, preferably greater than 70 rpm.
